(19) United States
(12) Patent Application Publication
(10) Pub. No.: US 2007/0173294 A1
(43) Pub. Date: Jul. 26, 2007

(54) A Multi-functional Bluetooth Loudspeaker

(76) Inventor: Chen Kuo Hsiung, KLN (HK)

Correspondence Address: JACK SHORE;MUCH SHELIST FREED DENENBERG AMENT&RUBENSTEIN,PC, 191 N. WACKER DRIVE, SUITE 1800, CHICAGO, IL, 60606-1615, US

(21) Appl. No.: 11/382,199

(22) Filed: May 8, 2006

(30) Foreign Application Priority Data
Jan. 20, 2006 (CN) 200620054305

(51) Int. Cl. H04B 7/00; H04M 1/00

(52) U.S. Cl. 455/569.1; 455/41.2

(57) ABSTRACT

This invention comprises a multi-functional loudspeaker including a loudspeaker body and a bluetooth transmission and reception device. It further includes at least one media player or a series of functional port(s), such as a DVD player, a three-in-one card reader, a FM/RDS radio receiver, a USB port, audio/visual outputs and SCART output. This novel system could transmit or receive audio signals via bluetooth technology and any bluetooth-enabled devices and is patentably distinct from previous bluetooth loudspeaker having only an audio play function.

### CROSS REFERENCE TO RELATED APPLICATION

This application claims priority to Chinese Utility Application 200620054305.1 filed on Jan. 20, 2006.

### TECHNICAL FIELDS

Applicant's novel invention relates to a wireless loudspeaker system, particularly a multi-functional loudspeaker using bluetooth technology.

### BACKGROUND TECHNOLOGIES

Existing loudspeakers are widely applied to Hi-Fi, television or being used as computer components. Nevertheless, the application of loudspeaker is strictly and invariable limited to audio transmission. Recently, JAZZ HIPSTER Corporation has launched a kind of bluetooth-enabled loudspeaker without any wires coming out. Despite it being convenient to use, such device is still strictly limited to audio transmission with no other function.

### DESCRIPTION OF INVENTION

The purpose of this novel loudspeaker is not only to provide a system with bluetooth transmission and reception of audio signals, but also to provide a multi-functional loudspeaker system.

The purpose of applicant's novel invention is achieved by a type of bluetooth loudspeaker composed of a speaker body and a bluetooth transmission and reception device. It is characterized by the inclusion of at least one media player including a series of functional ports on it.

The media player includes a DVD player or three-in-one card reader or FM/RDS radio receiver.

The three-in-one card reader is a SD/MMC/MS card reader.

The connectors include a USB port audio/visual outputs or a SCART output.

The loudspeaker is operated on batteries or DC power supply.

This utility model is superior to the existing technologies in that is (1) Equipped with a DVD player and audio signals can be transmitted to any bluetooth-enabled devices, such as bluetooth headphones, allowing the user to enjoy audio sound from a variety of these devices; (2) Equipped with a three-in-one card reader for playing audio files in various formats including MP3 and WMA, and these audio files could also be transmitted to any bluetooth-enabled devices such as, mobile phones and Bluetooth headphones for listening music; (3) With a built-in stereo FM/RDS radio receiver wherein channel scanning is featured, coupled with the efficient circuitry for best reception; and (4) This will enable reception of audio signals from any bluetooth-enabled devices like iPod players, computers, mobile phones, PlayStation Portable (PSP), Portable Media Players (PMP), MP3 players more easier.

### ATTACHED FIGURES

FIG. 1 shows the structure of the novel bluetooth loud speaker;

FIG. 2 shows the side view of the speaker of FIG. 1; and

FIG. 3 shows the application of the loudspeaker on other bluetooth-enabled devices.

### IMPLEMENTATION DETAILS

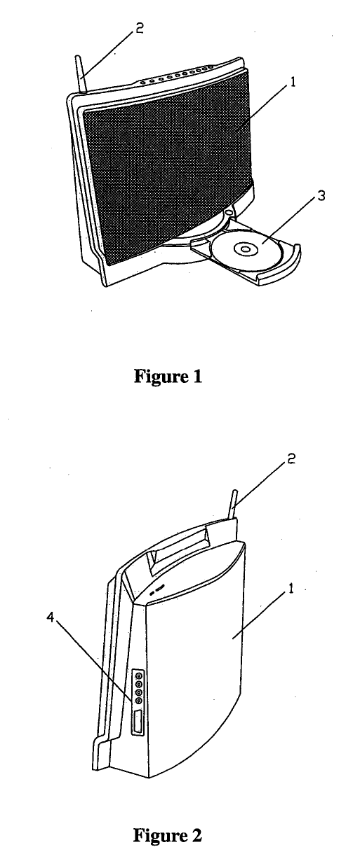

As shows in FIG. 1, a type of multi-functional bluetooth loudspeaker includes loudspeaker body 1, bluetooth transmission and reception device 2, as well as DVD Player 3. The DVD player is compatible with these formats: DVD, VCD, CD, MP3 and JPEG, etc. When using, a disc is played into the DVD Player 3 for playing music through loudspeaker body 1. Music can also be played by transmitting the audio signals to any bluetooth-enabled devices such as bluetooth headphones through bluetooth transmission and audio reception device 2. Besides, audio signals from other bluetooth devices could be received by bluetooth transmission and reception device 2, and played through loudspeaker body 1. The users are not surrounded by wires while enjoying the multi-functionality of this loudspeaker.

The said loudspeaker for various media players is in 2.1 Channel Design (Stereo). The media player can support A2DP (Advanced Audio Distribution Profile) and AVRCP formats.

The said bluetooth media player as a transmission distance of 10 meters.

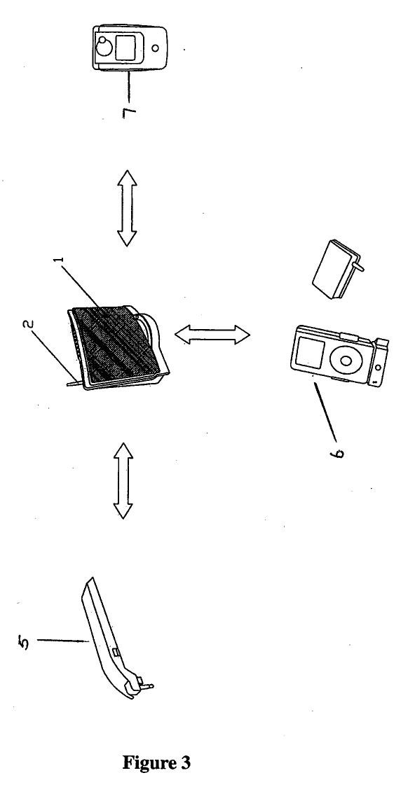

In addition, as per FIG. 2, this loudspeaker system can also be integrated with other devices or port(s) 4, such as, a three-in-one card reader (SD/MMC/MS), FM/RDS receiver, USP port audio/visual outputs or SCART outputs. Remote control is possible to minimize any possible damage on the loudspeaker.

FIG. 3 shows some examples of using this utility model with other bluetooth products. As can be seen in the figure, this loudspeaker can be connected to any mobile phone 7, iPod player 6, bluetooth TM transmitter 5, and other products with bluetooth reception and transmission functions.

This novel bluetooth loudspeaker is operated on batteries or DC power supply.

Above is a good example of implementation of bluetooth loudspeaker, but it is not limited to the above implementation example. Other modifications, decorations, substitutions, combinations, and simplifications not against the essential nature and principle of this utility model are all equivalent replacement modes within the protection range for this utility model an fall within the true spirit and scope of the invention as covered by the appended claims.

1. A multi-functional bluetooth loudspeaker system including a loudspeaker assembly having a built-in bluetooth transmitter and receiver and means for receiving one or more media components.

2. A multi-functional bluetooth loudspeaker system as set forth in claim 1 in which the media component comprises a DVD player.

3. A multi-functional bluetooth loudspeaker system as set forth in claim 1 in which the means for receiving include a series of functional parts including a USB port, audio/visual output or SCART output.

4. A multi-function loudspeaker system as set forth in claim 1 in which the media component is a three-in-one card reader.

5. A multi-functional loudspeaker system as set forth in claim 4 in which the three-in-one card reader is a 50/MMC/MS card reader.

6. A multi-functional loudspeaker system as set forth in claim 1 in which the media component is an FM/RDS radio.

7. A multi-functional loudspeaker system as set forth in claim 1 that is powered by batteries or a DC power supply.
